(19) United States
(12) Patent Application Publication
(10) Pub. No.: US 2007/0257398 A1
(43) Pub. Date: Nov. 8, 2007

(54) Laminated electronic components for insert molding

(76) Inventor: Scott E. Moncrieff, La Jolla, CA (US)

Correspondence Address: JAQUEZ & ASSOCIATES, 6265 Greenwich Drive, Suite 100D, SAN DIEGO, CA, 92122, US

(21) Appl. No.: 11/429,595

(22) Filed: May 4, 2006

(51) Int. Cl. B29C 70/88

(52) U.S. Cl. 264/272.11; 264/272.14; 264/138; 264/132

(57) ABSTRACT

An insert molded article is disclosed wherein the article comprises a laminated appliqué having as one layer of the laminate an electronic component. In one embodiment, the laminated appliqué includes a first substrate and an electronic component bonded to the first substrate. A second substrate is applied over the electronic component and is bonded to the first substrate. The resulting laminated appliqué may be flat or trimmed and formed into a three-dimensional shape which conforms to the shape of the molded article. The appliqué may then be placed in a mold and molten resin may be injected into the mold cavity over the appliqué to produce a one-piece, permanently bonded article containing the electronic component. Additional layers may be added to the appliqué, such as graphic layers, thermally activated adhesive layers and protective layers. A method of fabricating the insert molded article is also disclosed.

### BACKGROUND

1. Field

The present invention relates generally to the manufacture of molded plastic articles, and more particularly to a laminate comprising one or more films and electronic components such as an antenna or printed circuit, which is insert molded into a plastic article, and methods for producing such laminates and insert molded articles.

2. Description of Related Art

Numerous electronic devices such as cellular phones, MP3 players, radio receivers, radio transmitters, personal digital assistants (PDAs), integrated combinations of the foregoing and similar devices, comprise electronic components disposed on a chassis and contained in a housing or enclosure. The housing or enclosure typically includes multiple parts, including a top and bottom cover. Electronics components may also be mounted to the housing parts. The electronic components may include, for example, circuitry, microprocessor(s), memory, hard drive(s), antenna(s), switches and similar electronic devices. The chassis and housing are commonly formed of injection molded plastic parts.

It is known that components may be integrally formed with injection molded chassis and housing parts by a process known as insert molding. The insert molding process comprises a method of producing an article by placing one or more components of the article into a mold. The component(s) may be clamped or otherwise held in place (such as, for example, by suction) in the mold. Molten plastic resin may then be injected into the mold over the component(s). The result is a one-piece, permanently bonded article having the component(s) molded into the article. The technique of insert molding of electronic components into part of a housing is generally described in U.S. Patent Publication No. U.S. 2005/0001767 A1, the contents of which is incorporated herein by reference in its entirety.

Previously known insert molding processes have several shortcomings. For one, certain components may be damaged during the insert molding process due to contact with the molten resin. In addition, there is no means provided for forming the components to conform to the size and shape of the molded article. It may also be desirable to decorate the molded article with graphics and/or color.

Accordingly, there is a need for insert molded articles and a method for making them which overcomes the above-described deficiencies.

### SUMMARY

The present method and apparatus is directed to an insert molded article and method of producing such insert molded article. In one embodiment, the insert molded article comprises a laminated appliqué comprising a first substrate, which may be in the form of a thin film, and an electronic component laminated to the film. The electronic component may be simply bonded to the first substrate using an adhesive or it may be formed on the substrate such as by printing conductive ink onto the substrate. A second substrate may then be applied over the electronic component. The second substrate may be bonded over the electronic component using adhesive, a layer of curable ink applied between the substrates, catalyzing a bonding mechanism between the first and second substrates (such as heat, chemical process, ultra-sonic welding, etc.), or using some other suitable method. In some embodiments, additional substrate layers may be laminated onto the appliqué. For example, substrate layers, such as graphic layers and protective layers, may be laminated onto the appliqué by similar bonding processes or via a printed film.

The laminated appliqué may then be trimmed and formed to the desired shape and size, such as to conform to the size and shape of the molded article. The laminated appliqué may be trimmed using any suitable cutting process. The trimming can be performed to not only properly size the appliqué, but also to tune or adjust the electronic component such as, for example, an antenna. The appliqué may also be formed into a three-dimensional shape by thermal forming, vacuum forming, pressure forming, blow molding, or some other suitable process.

The appliqué is then placed into a mold and molten resin is injected into the mold over the appliqué. The part is removed from the mold resulting in a one-piece, permanently bonded article having the appliqué carrying the electronic component(s) molded into the part.

### BRIEF DESCRIPTION OF THE DRAWINGS

FIG. 1 is an exemplary, not to scale, exploded cross-sectional view of an appliqué for insert molding according to one embodiment of the present disclosure.

FIG. 2 is another exemplary, not to scale, exploded cross-sectional view of an appliqué for insert molding according to another embodiment of the present disclosure.

FIG. 3 is another exemplary, not to scale, exploded cross-sectional view of an appliqué for insert molding according to another embodiment of the present disclosure.

FIG. 4 is another exemplary, not to scale, exploded cross-sectional view of an appliqué for insert molding according to another embodiment of the present disclosure.

FIG. 5 is another exemplary, not to scale, exploded cross-sectional view of an appliqué for insert molding according to another embodiment of the present disclosure.

FIG. 6 is another exemplary, not to scale, exploded cross-sectional view of an appliqué for insert molding according to another embodiment of the present disclosure.

FIG. 7 is another exemplary, not to scale, exploded cross-sectional view of an appliqué for insert molding according to another embodiment of the present disclosure.

FIG. 8 is another exemplary, not to scale, exploded cross-sectional view of an appliqué for insert molding according to another embodiment of the present disclosure.

FIG. 9 is another exemplary, not to scale, exploded cross-sectional view of an appliqué for insert molding according to another embodiment of the present disclosure.

FIG. 10 is another exemplary, not to scale, exploded cross-sectional view of an appliqué for insert molding according to another embodiment of the present disclosure.

FIG. 11 is another exemplary, not to scale, exploded cross-sectional view of an appliqué for insert molding according to another embodiment of the present disclosure.

FIG. 12 is another exemplary, not to scale, exploded cross-sectional view of an appliqué for insert molding according to another embodiment of the present disclosure.

FIG. 13 is another exemplary, not to scale, exploded cross-sectional view of an appliqué for insert molding according to another embodiment of the present disclosure.

FIG. 14 is another exemplary, not to scale, exploded cross-sectional view of an appliqué for insert molding according to another embodiment of the present disclosure.

FIG. 15 is another exemplary, not to scale, exploded cross-sectional view of an appliqué for insert molding according to another embodiment of the present disclosure.

FIG. 16 is another exemplary, not to scale, exploded cross-sectional view of an appliqué for insert molding according to another embodiment of the present disclosure.

FIG. 17 is a chart illustrating various combinations of layers that can be used in an appliqué for insert molding according to another embodiment of the present teachings.

### DETAILED DESCRIPTION

Referring now to the figures, the insert molded article and method for producing same according to the present teachings are described in detail. Throughout the figures, like reference numerals refer to like elements, and the description for like elements are applicable for all described embodiments wherever relevant.

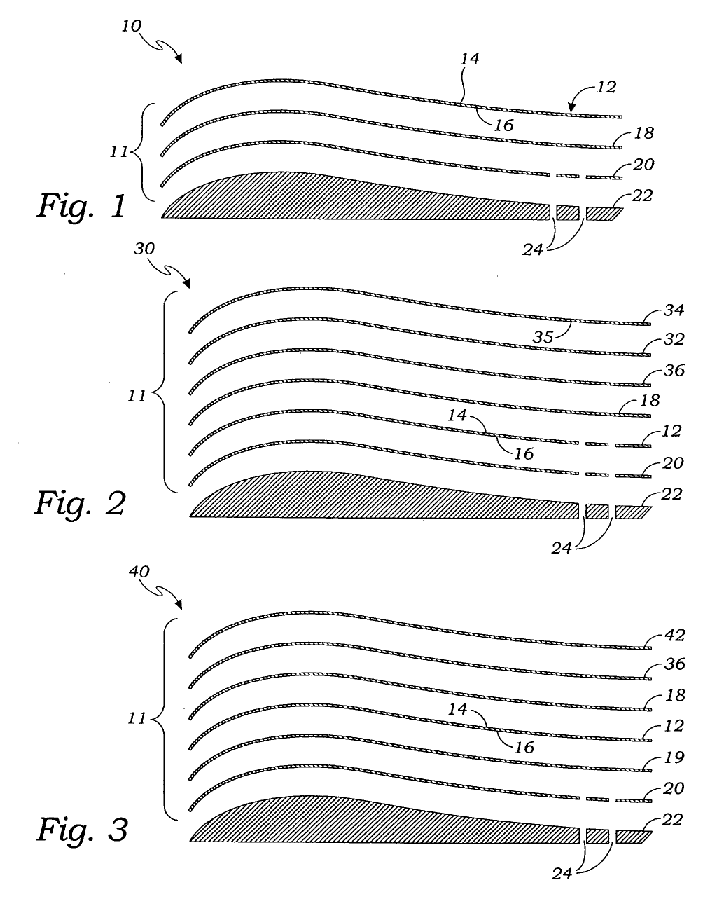

Turning first to FIG. 1, the insert molded article 10 comprises an appliqué 11 integrally formed to a molding resin 22. In one embodiment, the appliqué 11 according to the present method and apparatus comprises all of the laminates structure of the insert molded article 10, except the molding resin 22.

In the embodiment shown in FIG. 1, the appliqué 11 comprises a base substrate 12 having a top surface 14 and a bottom surface 16. In some embodiments, the base substrate 12 (as well as all of the other substrates described herein) may comprise a plastic film, a textile, a paper, foil, a metallized polymer film or one or more layers of such materials. Numerous plastic films are suitable for the base substrate 12 material (as well as all of the other substrates described herein), including without limitation, polymers and copolymers such as polycarbonate, polyvinyl, polyurethane, polystyrene, polyamide, polyester, fluoropolymer, among others. The base substrate 12 may be substantially transparent (including transparent), translucent, or opaque, depending on the application as described below.

In the embodiment shown in FIG. 1, an electronic component 18 is disposed on the bottom surface 16 of the base substrate 12. The electronic component 18 may comprise any type of electronic component such as a conductive layer, an antenna, a flexible circuit board, conductive trace lines for a circuit, memory, a microprocessor, a hard drive, electrical connections, or the like. For example, in some embodiments, the electronic component 18 may comprise a circuit or other conductive material printed directly onto the bottom surface 16 or printed on a separate film substrate. In some embodiments, the electronic component 18 may also comprise a conductive layer formed of copper foil, aluminum foil, screen printed conductive ink (silver, carbon, copper, gold, platinum or other conductive metal), a metal vapor deposition layer, a vacuum metalized layer, or a sputtered metalized layer. The circuit pattern may also be created using conventional methods for making an etched circuit using copper clad or metalized film substrates for the patterned circuit material.

In some embodiments, the electronic component 18 may be bonded to the bottom surface 16 by any suitable method, including without limitation, using an adhesive, a thermally activated adhesive layer, a radiation curable adhesive, a radiation curable ink, or a lamination adhesive.

In some embodiments, an adhesion promotion layer 20 may be disposed onto the bottom surface of the electronic component 18 (and also to the areas of the base substrate 12 not covered by the electronic component 18) which promotes adhesion of the molding resin 22 to the appliqué 11 during the molding process described below. In some embodiments, the adhesion promotion layer 20 may comprise a thermally activated adhesive layer or other suitable adhesion layer.

If any curable inks, adhesives or layers are utilized in forming the appliqué 11, a curing step may be performed at an appropriate time. For example, the curing step may be performed immediately after applying the curable material and any substrate to which it is intended to bond, or after other layers of the appliqué 11 have been applied.

In some embodiments, once the layers of the appliqué 11 have been applied, the appliqué 11 will, in some embodiments, comprise a flat sheet. At this point, the appliqué 11 may be trimmed to a desired shape and size for the insert molded article 10. In some embodiments, a die may be used to trim the appliqué 11.

In some embodiments, at this point in the fabrication process, the insert molded article 10 may not have a flat shape similar to the appliqué 11. Instead, the insert molded article 10 may have a three-dimensional shape. Accordingly, the appliqué 11 may be formed into a desired three-dimensional shape, such as a shape that conforms to the shape of the molded article 10, or a surface or portion of the molded article 10. For example, as shown in the figures, the appliqué 11 may be formed to have a curved or wavy shape. The appliqué 11 may be formed in the three-dimensional shape by thermal forming, vacuum forming, pressure forming, and blow molding, or using some other suitable process.

At any stage of the appliqué 11 forming process, the electronic component 18 may be electrically trimmed, tuned or modified for optimal performance characteristics as required for a given application. For example, if the electronic component 18 comprises an antenna for a cell phone, the antenna length may be adjusted by trimming the antenna to tune it for a given cell phone.

Once the appliqué 11 is complete, it may be placed into an injection molding mold. The appliqué 11 may simply sit in the mold, or it may be held in place in the mold by clamps, clips, suction or other suitable means. Also, the appliqué 11 may not bear against a wall of the mold, but may be spaced apart from the wall of the mold, such as by using spacers. In this way, molten resin injected into the mold over the appliqué 11 can be placed around any part of the appliqué 11. Alternatively, a surface of the appliqué 11 can be placed directly against a wall of the mold so that the surface of the appliqué 11 that is placed against the wall will be on the outside surface of the finished article 10. Molten resin may then be injected into the mold over the appliqué 11. In one embodiment, the heat from the molten resin activates the adhesion promotion layer 20 such that when the molten resin cools to form the molding resin 22, there is good adhesion between the appliqué 11 and the molding resin 22. Once the molding resin cools sufficiently to set the molding resin 22, the finished article 10 may be removed from the mold. The result is a one-piece, permanently bonded insert molded article 10 having an appliqué 11 with an electronic component 18 molded into the article 10.

In order to provide access to the electronic component 18, such as for electrical connections, access apertures 24 may be included. The electrical connection may comprise pins, wires, via, or built-in flex connectors, attached by conventional methods. The access apertures 24 may extend through any one or more of the layers of the appliqué 11, such as through the molding resin 22 and through the adhesion promotion layer 20, as shown in the embodiment of FIG. 1.

Turning now to FIG. 2, another embodiment of an insert molded article 30 according to the present disclosure is shown. The insert molded article 30 is similar to the insert molded article 10 described above with reference to FIG. 1, except that the article 30 also includes one or more graphic layer(s) 32 and a graphic film substrate 34, and the electronic component 18 is applied to the top surface 14 of the base substrate 12. A lamination adhesive 36 may also be provided in order to bond the graphic layer(s) 32 and/or the graphic film substrate 34 to the remainder of the appliqué 11. The lamination adhesive 36 may comprise any suitable adhesive, such as a radiation or heat curable liquid adhesive, a curable ink, or other adhesive as known by those of ordinary skill in the art. The lamination adhesive 36 may be applied by printing, such as by screen printing, or other suitable method.

The graphic layer(s) 32 may be applied to the bottom surface 35 of the graphic film substrate 34. The graphic layer(s) may include any graphic design, including without limitation, ornamental, informational, labeling, coloring or other graphics. The graphic layer(s) may be applied by any suitable method, for example by screen printing, lithography, gravure, offset, reprography, ink jet, laser, flexography, or electronic means. Methods of providing graphics for an in-mold label are described in detail in U.S. patent application Ser. No. 10/914,812, filed Aug. 9, 2004, now abandoned, the contents of which is hereby incorporated herein by reference in its entirety. The graphic layer(s) 32 may be applied all at once, or in a series of printing steps. In accordance with one method, after the graphic layer(s) 32 are applied to the graphic film substrate 34, the lamination adhesive 36 is applied over the entire bottom surface 35 of the graphic film substrate 34, including over the graphic layer(s) 32. The electronic component 18 and base substrate 12 may then be applied to these layers. When the lamination adhesive 36 comprises a curable adhesive, such as radiation curable ink, the adhesive 36 is cured thereby bonding the graphic film substrate 34 to the electronic component 18 and the base substrate 12. Alternative to using graphic layer(s) 32, or in addition to the graphic layer(s) 32, the graphic film substrate 34 may also include a graphic design pre-printed onto the substrate 34.

Another insert molded article 40 according to the present disclosed method and apparatus is shown in FIG. 3. The insert molded article 40 is quite similar to the insert molded article 30 described above with reference to FIG. 2, except that the article 40 includes a second electronic component 19 disposed on a side of the base substrate 12 that is opposite the first electronic component 18. Also, instead of graphic layer(s) 32 and a graphic film substrate 34 as used in the article 30 of FIG. 2, the article 40 of FIG. 3 utilizes a simple lamination substrate 42. The second electronic component 19 may comprise any of the types of components described above for the first electronic component 18, and may or may not be electronically coupled to the first electronic component 18.

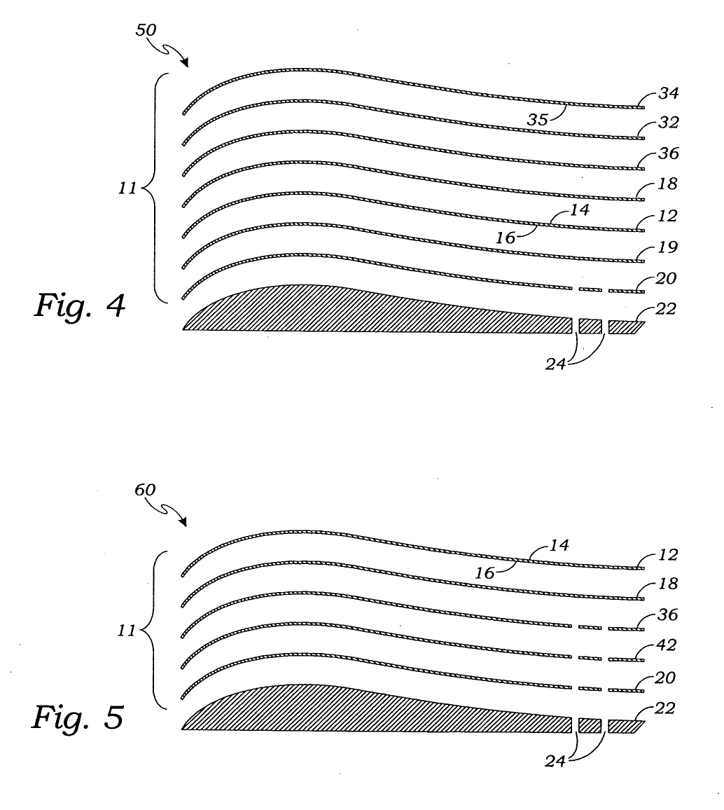

Similar to the insert molded article 40 described above, an insert molded article 50 of FIG. 4 includes two electronic components 18 and 19. However, the article 50 of FIG. 4 includes one or more graphic layer(s) 32 and a graphic film substrate 34. In addition, any number of additional layers of electronic components and base substrates as required by a particular application can be applied above or below the base substrate 12.

The insert molded article 60 of FIG. 5 is the same as the article 10 described above with reference to FIG. 1, except that the article 60 includes a lamination substrate 42 disposed between the electronic component 18 and the adhesion promotion layer 20. As described above with reference to FIGS. 2 and 3, the lamination substrate 42 may be bonded to the electronic component 18 and/or the base substrate 12 using the lamination adhesive 36.

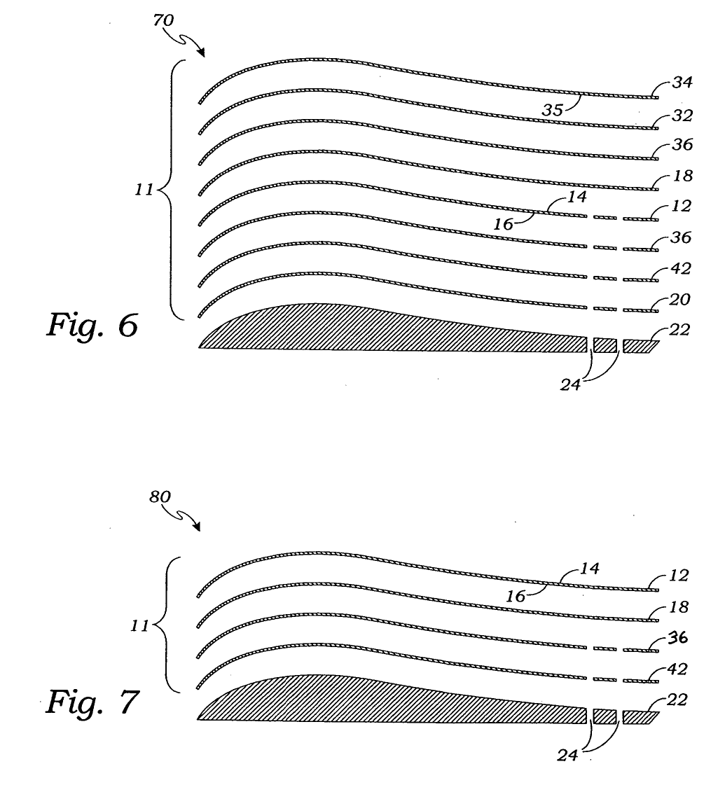

Referring now to FIG. 6, an insert molded article 70 is very similar to the article 30 described above with reference to FIG. 2, except that the article 70 includes a lamination substrate 42 disposed between the base substrate 12 and the adhesion promotion layer 20. As described above, the lamination substrate 42 may be bonded to the adjacent layer, in this case the base substrate 12, using a lamination adhesive 36.

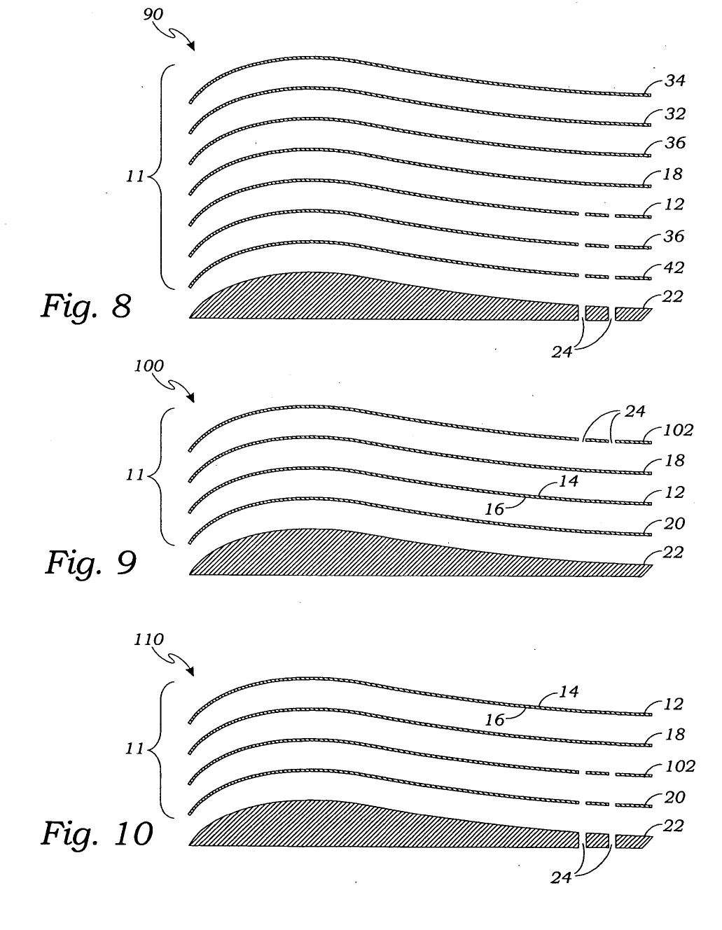

The insert molded article 80, shown in FIG. 7, is very similar to the insert molded article 60 of FIG. 5, except that the article 80 does not include an adhesion promotion layer. Indeed, if the application does not require it, any of the embodiments described herein as including an adhesion promotion layer may be fabricated without such an adhesion promotion layer. For example, the insert molded article 90 of FIG. 8 is the same as the insert molded article 70, except that it excludes the adhesion promotion layer 20.

Turning to FIG. 9, an insert molded article 100 is very similar to the insert molded article 30 described above with reference to FIG. 2, except that the article 100 includes a dielectric layer or coating 102 disposed over the electronic component 18 instead of graphic layers and a graphic film. The coating 102 may be applied by any of the printed methods described herein or other suitable method. The dielectric layer 102 may comprise a printed dielectric material such as a non-conductive ink or other curable liquid, or a non-conductive sheet of film. The dielectric layer 102 may be applied to the entire surface covering the electronic component 18 and the base substrate 12, or it may be applied in a desired pattern to provide selective electrical insulation or conductivity.

An insert molded article 110 of FIG. 10 is similar to the article 100 of FIG. 9, except that the dielectric layer 102 and electronic component 18 are applied to the bottom surface 16 of the base substrate 12.

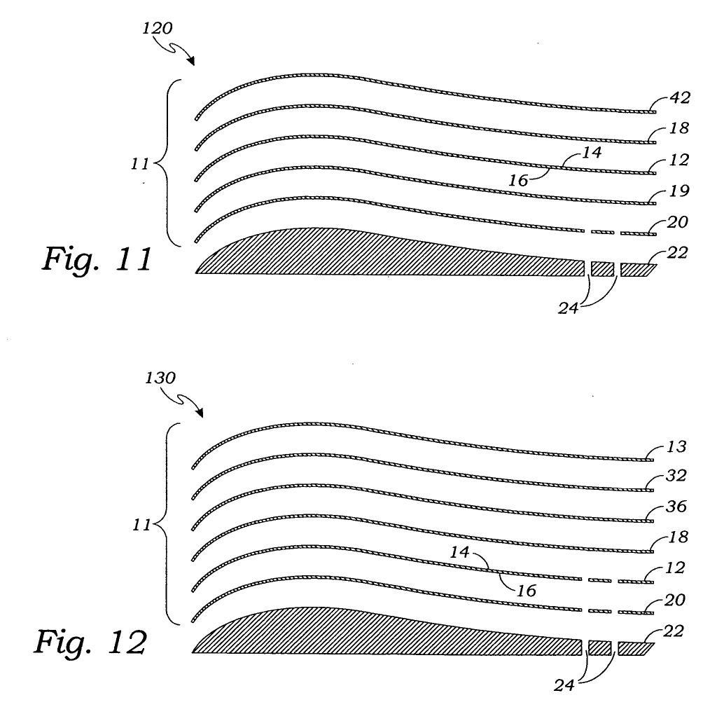

Referring to FIG. 11, an insert molded article 120 is similar to the article 40 described above with reference to FIG. 3 having two electronic components 18 and 19, except that the article 120 excludes the lamination adhesive 36. In certain applications, no adhesive may be required to bond the lamination substrate 42 to the electronic component 18 and/or the base substrate 12. For example, the molding resin may be applied to both sides of the appliqué 11 thereby permanently holding the lamination substrate 42 to the remainder of the appliqué 11.

Another exemplary insert molded article 130 is shown in FIG. 12. The insert molded article 130 of FIG. 12 is very similar to the article 30 of FIG. 2, except that the article 130 replaces the graphic film substrate 34 (shown in FIG. 2) with a second base substrate 13.

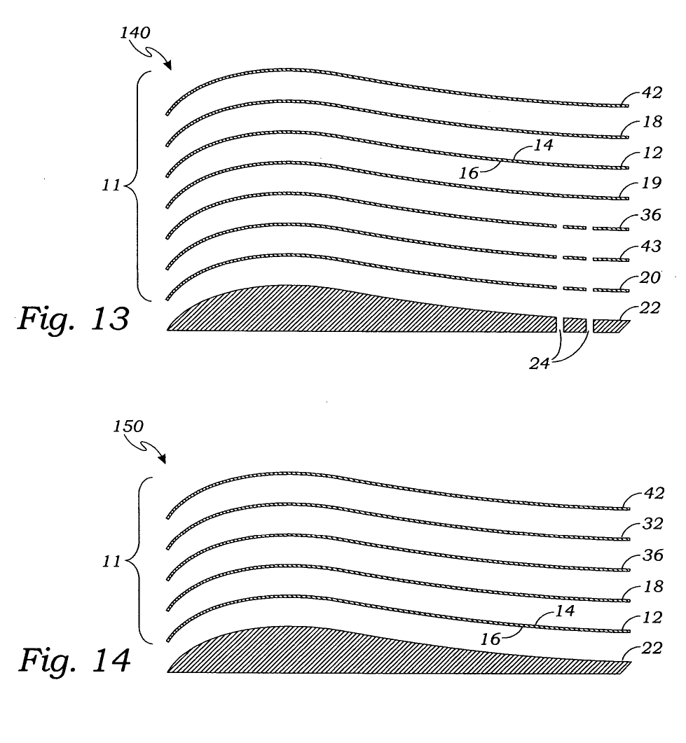

Turning now to FIG. 13, an insert molded article 140 is very similar to the insert molded article 120 described above with reference to FIG. 11, except that the article 140 includes a second lamination substrate 43 disposed between a second electronic component 19 and an adhesion promotion layer 20. The second lamination substrate 43 may have the same characteristics as described above for the lamination substrate 42. As shown in FIG. 13, the article 140 also includes a lamination adhesive 36.

Another embodiment of an insert molded article 150, illustrated in FIG. 14, is very similar to the molded article 30 of FIG. 2 described above, except that the article 150 of FIG. 14 replaces the graphic film substrate 34 disposed over the graphic layer(s) 32 with a lamination substrate 42. Also, as shown in FIG. 14, the article 150 does not include an adhesion promotion layer 20.

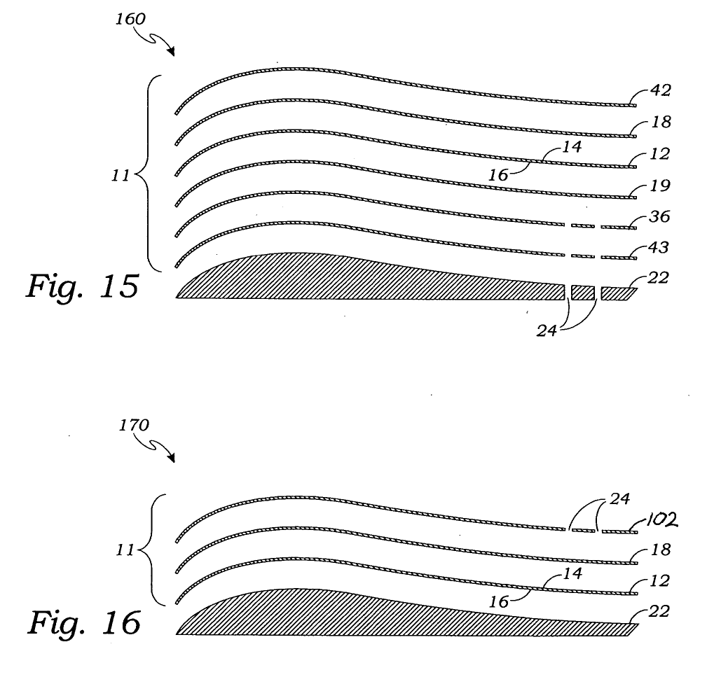

FIG. 15 shows yet another embodiment of an insert molded article 160 according to the present method and apparatus. The insert molded article 160 is very similar to the insert molded article 140 described above with reference to FIG. 13, except that the article 160 excludes the adhesion promotion layer 20.

In FIG. 16, another embodiment of the insert molded article 170 is shown. The article 170 is very similar to the insert molded article 100 of FIG. 9, except that the article 170 excludes the adhesion promotion layer 20.

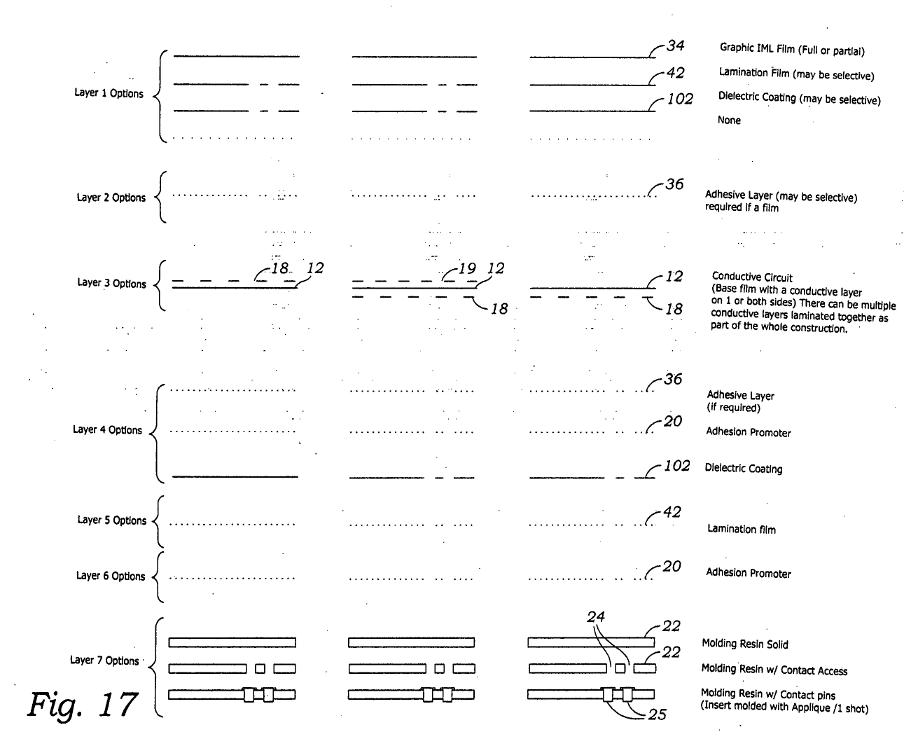

While each of the above embodiments of the present insert molded articles includes various layers that can be combined to form an appliqué according to the present disclosure, FIG. 17 provides a convenient summary of the numerous additional appliqués that are possible according to the present method and apparatus. The three columns of FIG. 17 represent three possible basic configurations of the electronic components 18 and 19 and a base substrate 12. For example, in column 1 (the left column) the electronic component 18 is disposed above the top surface of the base substrate 12; in column 2 (the middle column) the electronic components 18 and 19 are disposed both above and below the base substrate 12; and in column 3 (the right column) the electronic component 18 is disposed below the base substrate 12. As shown in FIG. 3, for example, the electronic component 18 may be disposed above the base substrate 12, and the electronic component 19 below, or vice versa. The rows show options that may be utilized for any particular layer. For example, Layer 4 could comprise a lamination adhesive layer 36, an adhesion promotion layer 20, or a dielectric layer or coating 102.

According to the chart of FIG. 17, any permutation of the various layers may be utilized in the relative location shown in the chart, wherein each of the seven layers may be selective or required depending on the intended application and the other layers being utilized. In addition, contact pins 25 may be insert molded directly into the insert molded article in a single shot.

As is known, there are benefits to being able to place an antenna as far away as possible from a circuit board, processor, etc., within a hand-held electronic device. For example, some antennas do not function well when positioned 4 mm, but function well when positioned at 5 mm from a circuit board. In some applications, it has become a functional requirement to locate the component in the outer skin of the housing. Very specific placement and positioning of antenna components, for example, is critical for providing imposed functionality. The method of manufacturing according to the present disclosure solves the problems of location, position and placement of electronic components. In-mold labeling with robotic loading can provide very accurate and repeatable results.

The insert molded articles described above can be used in many applications, including, for example, as chassis parts, housings, covers or other components of various electronic devices such as cellular phones, MP3 players, radio receivers, radio transmitters, personal digital assistants (PDAs), and integrated combinations of the foregoing and similar devices. For example, for a cell phone cover, the electronic component 18 may comprise an antenna which is applied into an appliqué 11 as described and then insert molded into the cover piece of the cell phone.

While the present method and apparatus have been fully described above with particularity and detail, it will be apparent to those of ordinary skill in the art that many modifications thereof may be made without departing from the principles and concepts set forth herein. Hence, the proper scope of the present method and apparatus should be determined only by the broadest interpretation of the appended claims so as to encompass all such modifications and equivalents.

In addition, although particular features of the disclosed method and apparatus may have been disclosed with respect to only certain of the multiple embodiments, such features may be combined with one or more other features of the other embodiments as may be desired for any particular application.

1. A method of producing a molded article, the method comprising the steps of:
producing a laminated appliqué by (i) providing a first substrate having a top surface and a bottom surface, (ii) placing a first electronic component onto one of said top surface or said bottom surface of said first substrate, (iii) applying a second substrate onto said first electronic component and bonding said second substrate to at least one of said first substrate and said electronic component;
placing said appliqué into an injection molding mold;
injecting molten resin over said appliqué.

2. The method of claim 1 further comprising the step of forming said appliqué into a three-dimensional shape prior to said step of injecting molten resin over said appliqué.

3. The method of claim 1 further comprising the step of trimming said appliqué to a desired shape and size.

4. The method of claim 1 wherein said step of producing a laminated appliqué further comprises the step of applying at least one graphic layer onto said second substrate.

5. The method of claim 1 wherein said step of producing a laminated appliqué further comprises the step of applying a lamination adhesive between said second substrate and at least one of said first substrate and said first electronic component.

6. The method of claim 4 wherein said lamination adhesive comprises one of the following: a thermally activated adhesive layer, a radiation curable adhesive, a radiation curable ink, or a lamination adhesive.

7. The method of claim 1 wherein said first substrate is made of one of the following plastics: polycarbonate, polyvinyl, polyurethane, polystyrene, polyamide, polyester, petg or fluoropolymer.

8. The method of claim 4 wherein said step of producing a laminated appliqué further comprises the step of applying a second electronic component on the opposing side of said first substrate as said first electronic component.

9. The method of claim 8 wherein said step of producing a laminated appliqué further comprises the step of applying a lamination substrate onto said second electronic component and bonding said lamination substrate to at least one of said second electronic component and said first substrate.

10. The method of claim 8 wherein said step of producing a laminated appliqué further comprises the step of applying a dielectric layer onto said first electronic component.

11. A method of producing a molded article, the method comprising the steps of:
producing a laminated appliqué by (i) providing a first substrate having a top surface and a bottom surface, (ii) placing an electronic component onto said bottom surface of said first substrate;
placing said appliqué into an injection molding mold; and
injecting molten resin over said appliqué.

12. The method of claim 11 further comprising the step of forming said appliqué into a three-dimensional shape, wherein said step of forming is performed prior to said step of placing said appliqué into an injection molding mold.

13. The method of claim 11 wherein said step of producing a laminated appliqué further comprises the step of applying a second substrate over said electronic component and bonding at least a portion of said second substrate to at least a portion of said first substrate.

14. The method of claim 11 further comprising the step of trimming said appliqué to a desired shape and size.

15. The method of claim 11 wherein said step of producing a laminated appliqué further comprises the step of applying at least one graphic layer onto at least one of the following: said first substrate and a graphic film substrate applied onto said first substrate.

16. The method of claim 14 wherein said step of producing a laminated appliqué further comprises the step of applying a lamination adhesive between said first substrate and said graphic film substrate and wherein said lamination adhesive comprises one of the following: a thermally activated adhesive layer, a radiation curable adhesive, a radiation curable ink, or a lamination adhesive.

17. The method of claim 1 wherein said first substrate is made of one of the following plastics: polycarbonate, polyvinyl, polyurethane, polystyrene, polyamide, polyester or fluoropolymer.

18. The method of claim 4 wherein said step of producing a laminated appliqué further comprises the step of applying a second electronic component on the opposing side of said first substrate as said first electronic component.

19. The method of claim 18 wherein said step of producing a laminated appliqué further comprises the step of applying a lamination substrate onto said second electronic component and bonding said lamination substrate to at least one of said second electronic component and said first substrate.

20. The method of claim 18 wherein said step of producing a laminated appliqué further comprises the step of applying a dielectric layer onto said first electronic component.

21. An insert molded article, comprising a laminated appliqué integrally formed to a molding resin, wherein the laminated appliqué comprises:
(a) a base substrate having a top and bottom surface;
(b) a first electronic component disposed on one of the top and bottom surfaces of the base substrate, wherein the first electronic component is bonded to the base substrate; and
(c) a second substrate applied on the first electronic component, wherein the second substrate is bonded to at least one of the base substrate and the first electronic component; wherein the base substrate, first electronic component, and second substrate are integrally formed to the molding resin by a molding process.

22. The insert molded article of claim 21, wherein the base substrate comprises one of the following materials: plastic film, textile, paper, foil, metallized polymer film or one or more layers of such materials.

23. The insert molded article of claim 22, wherein the base substrate comprises one of the following plastic film materials: polymer, copolymer, polycarbonate, polyvinyl, polyurethane, polystyrene, polyamide, polyester, and fluoropolymer.

24. The insert molded article of claim 21, wherein the base substrate is substantially transparent, translucent, or opaque.

25. The insert molded article of claim 21, wherein the first electronic component comprises one of the following: a conductive layer, an antenna, a circuit board, conductive trace lines for an electronic circuit, a memory, a microprocessor, a hard drive, and electrical connectors.

26. The insert molded article of claim 25, wherein the first electronic component comprises an electrical circuit printed directly on one of the surfaces of the base substrate.

27. The insert molded article of claim 25, wherein the first electronic component comprises conductive material printed directly on one of the surfaces of the base substrate.

28. The insert molded article of claim 25, wherein the appliqué further comprises a film substrate, wherein the first electronic component is printed on the film substrate.

29. The insert molded article of claim 21, wherein the first electronic component comprises a conductive layer formed of one of the following: copper foil, aluminum foil, screen printed conductive ink, a metal vapor deposition layer, a vacuum metalized layer, or a sputtered metalized layer.

30. The insert molded article of claim 21, wherein the first electronic component comprises an etched electronic circuit comprising a copper clad or metalized film substrate.

31. The insert molded article of claim 21, wherein the first electronic component is bonded to the base substrate using the following bonding mechanisms: an adhesive such as a thermally activated adhesive layer, a radiation curable adhesive, a radiation curable ink, and a lamination adhesive.

32. The insert molded article of claim 21, wherein the first electronic component has a top and bottom surface, and wherein the first electronic component comprises an adhesion promotion layer disposed on the bottom surface of the electronic component.

33. The insert molded article of claim 32, wherein the adhesion promotion layer promotes adhesion of the molding resin to the appliqué during the molding process.

34. The insert molded article of claim 33, wherein the adhesion promotion layer comprises a thermally activated adhesive layer.

35. The insert molded article of claim 21, wherein the appliqué comprises an approximately flat sheet.

36. The insert molded article of claim 21, wherein the appliqué comprises an approximately three-dimensional sheet.

37. The insert molded article of claim 21, wherein the laminated appliqué is trimmed to a desired size and shape.

38. The insert molded article of claim 37, wherein the laminated appliqué is formed to a desired shape using one of the following forming methods: thermal forming, vacuum forming, pressure forming, and blow molding.

39. The insert molded article of claim 21, wherein the first electronic component is electrically tuned or modified to produce a desired performance characteristic.

40. The insert molded article of claim 39, wherein the first electronic component comprises an antenna having a length and width, and wherein the antenna length and width is adjusted by trimming the antenna and thereby tuning it to produce desired electrical characteristics.

41. The insert molded article of claim 21, further including one or more access apertures disposed through one or more of the molding resin, the second substrate, the first electronic component and the base substrate, and wherein the access apertures provide access to the first electronic component.

42. The insert molded article of claim 41, wherein the access apertures provide electrical connections to the first electronic component.

43. The insert molded article of claim 42, wherein the electrical connection comprises one of the following: pins, wires, built-in flex connectors, attached to the first electrical component via conventional methods.

44. The insert molded article of claim 21, wherein the appliqué further comprises one or more graphic layers and a graphic film substrate.

45. The insert molded article of claim 44, wherein the one or more graphic layers and the graphic film substrate are bonded to the appliqué using a lamination adhesive.

46. The insert molded article of claim 45, wherein the lamination adhesive comprises one of the following: a radiation curable liquid adhesive, a heat curable liquid adhesive, and a curable ink.

47. The insert molded article of claim 45, wherein the lamination adhesive is applied by using a printing method.

48. The insert molded article of claim 44, wherein the one or more graphic layers may include graphic designs including one or more of the following graphic designs: ornamental, informational, labeling, coloring and other graphics.

49. The inset molded article of claim 44, wherein the one or more graphic layers are by any of the following application methods: screen printing, lithography, gravure, offset, reprography, inkjet, laser, flexography, and electronic application methods.

50. The insert molded article of claim 44, wherein the graphic film substrate includes one or more graphic designs pre-printed on the graphic film substrate.

51. The insert molded article of claim 21, wherein the appliqué further comprises a second electronic component disposed on a surface of the base substrate opposite the first electronic component.

52. The insert molded article of claim 51, wherein the appliqué includes a lamination substrate.

53. The inset molded article of claim 51, wherein the appliqué further comprises one or more additional electronic components and one or more additional base substrates.

54. The inset molded article of claim 21, wherein the appliqué further comprises a dielectric layer or coating disposed over the first electronic component.

55. The insert molded article of claim 54, wherein the dielectric layer or coating is applied to an entire surface of the first electronic component and base substrate.

56. The insert molded article of claim 54, wherein the dielectric layer or coating is applied in a desired pattern to provide selective areas of electrical insulation and electrical conductivity.

57. The insert molded article of claim 51, wherein one or more of the first and second electronic components comprises an antenna for use in a cell phone, and wherein the laminated appliqué is trimmed to a desired configuration thereby tuning the antenna to meet desired reception and transmission performance characteristics of the cell phone.

58. A molded article comprising:
(a) a laminated appliqué, wherein the laminated appliqué comprises:
(1) a base substrate means, wherein the base substrate means includes a top surface and a bottom surface;
(2) a first electronic component means disposed on one of the top and bottom surfaces of the base substrate means, wherein the first electronic component means is bonded to the base substrate means; and
(3) a second substrate means applied on the first electronic component means, wherein the second substrate means is bonded to at least one of the base substrate means and the first electronic component means; and
(b) means for placing the laminated appliqué into an injection molding mold; and
(c) means for injecting molten resin over the laminated appliqué.
